(19) United States
(12) Patent Application Publication
(10) Pub. No.: US 2008/0291441 A1
(43) Pub. Date: Nov. 27, 2008

(54) Spectroscopic Support

(75) Inventors: David Klug, London (GB); Paul Donaldson, London (GB)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: IMPERIAL INNOVATIONS LIMITED, London (GB)

(21) Appl. No.: 11/571,810

(22) PCT Filed: Jul. 8, 2005
(86) PCT No.: PCT/GB05/02707

§ 371 Date: Mar. 9, 2007

(30) Foreign Application Priority Data
Jul. 9, 2004 (GB) 0415438.1

(51) Int. Cl. G01N 21/01

(52) U.S. Cl. 356/244

(57) ABSTRACT

A porous sample support provides a matrix into the pores or interstitial spaces of which a sample to be subjected to a spectroscopic analysis can be introduced. 2 D infrared spectroscopy can then be carried out on the sample at higher concentrations with minimized background.

The invention relates to a spectroscopic support.

The invention relates to a spectroscopic support for example a spectroscopic support for use in two-dimensional infrared spectroscopy.

A range of spectroscopic approaches are known for investigating the coupling of two or more two-level systems. One known approach is two-dimensional nuclear magnetic spectroscopy (2 D-NMR). An example of such a system is described in Friebolin, “Basic one- and two-dimensional NMR spectroscopy” 2^{nd} edition (April 1993) John Wiley & Sons. NMR relies on the interaction of magnetic nuclei with an external magnetic field, as is-well known. In order to spread out crowded data in an NMR spectrum, 2 D NMR has been developed. In a typical 2 D-NMR scheme the sample is subjected to first and second excitation pulses separated by a delay interval. Because of interactions within the sample and in particular spin-spin coupling, information obtained from the second excitation pulse differs from the information obtained from the first excitation pulse providing an extra dimension. A Fourier transformation is applied to the fine spectrum from each excitation pulse to obtain a respective frequency spectrum. The frequency spectra are plotted on orthogonal axes to form a surface. Peaks on the surface provide additional information concerning interactions within the sample.

2 D-NMR plots can be used to determine molecular structure and provide unique, characteristic features (“fingerprints”) for identifying components in a solution. There are a great many applications for the analysis of complex mixtures of molecules in chemistry, biology, and other disciplines. However 2 D-NMR suffers from a lack of sensitivity, with detection limits typically on the order 10¹⁴-10¹¹ molecules. In addition 2 D-NMR provides only limited resolution in the time domain.

In another known method of spectroscopy, techniques analogous to those used in 2 D-NMR spectroscopy have been adopted in 2 D vibration or infrared (IR) spectroscopy, where vibrational modes of an atom or molecule are excited. One such known technique is the so-called “pump-probe” technique as described in Woutersen et al “Structure Determination of Trialanine in Water Using Polarization Sensitive Two-Dimensional Vibrational Spectroscopy” J. Phys. Chem. B 104, 11316-11326, 2000. Further 2 D-IR pump-probe experiments have been performed, for example as described in Hamm et al “The two-dimensional IR non-linear spectroscopy of a cyclic penta-peptide in relation to its three-dimensional structure” Proc. Nat Acad. Sci. 96, 2036, 1999.

According to known 2 D IR systems a first pump pulse is followed by a probe pulse and the resulting frequency spectra plotted on respective axes to provide a surface representing information about vibration-vibration interactions in the sample. Because the mathematical description of any coupled two-level quantum systems is essentially identical, the analytical principles and techniques used in 2 D-NMR are largely applicable in 2 D IR spectroscopy. However detectivity is severely limited by input laser noise and the results show extremely small changes on a large background signal, in particular small changes in the intensity of an incident beam caused by equally small changes in the optical density of a sample. As a result there is much lower sensitivity to concentrations of the component of interest.

In principle 2 D optical spectroscopies also allow the measurement of coupling between pure electronic and vibrational states and between electronic states.

This is particularly relevant to the study of transition metal complexes and compounds where a large number of weak electronic states may be present in the infra-red region of the spectrum.

Another problem that arises in some instances is that the excitation and detective wavelengths are in the mid-infrared hence suffering from the problem of poorly performing detectors and high background from the sample itself in that region.

A further improvement in 2 D infrared spectroscopic techniques is described in co-pending GB patent application no. 0326088.2 which is incorporated herein by reference. According to the approach described in that application a sample is excited by an infrared excitation source and interactions between vibrations in the system allow two-dimensional information to be obtained. The excitation source and/or sample parameters are tuned to allow heterodyne rather than homodyne detection and the detected signal is processed such that the detected output field varies effectively linearly with concentration. As a result much lower concentrations can be analysed than with homodyne detection.

A problem with existing approaches is that the sample tends to be provided in solution. As a result the sample is only present in low concentrations. In addition the solvents tend to have a high IR signature which can swamp the useful signal.

The invention is set out in the claims.

Because of the provision of a sample support in the form of a porous body, the sample being held in the pores, high concentrations of the sample can be obtained. Furthermore selection of an IR silent material for the support (i.e. a material having a low IR signature in the spectral region of interest) is possible as a result of which the contribution of background radiation can be minimized. Yet further the provision of a solid state matrix as the sample support allows ting of the material to enhance heterodyne detection. Further advantages include removing the need for optical windows which also add background signal, the potential for using the porous material as a filter for concentrating the sample, enabling a simple evanescent-wave detection geometry, and the possibility that the porous material itself may be used as a pre-separation matrix such as a polyacrylamide gel, which are currently widely used for protein separations.

Embodiments of the invention will now be described, by way of example, with reference to the drawings, of which:

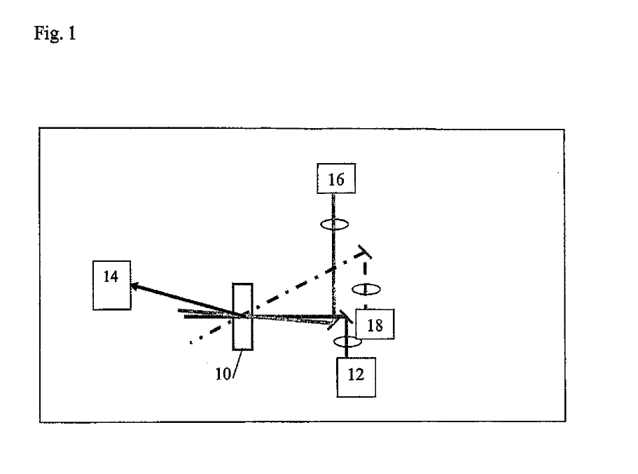

FIG. 1 shows an apparatus for performing a method of spectroscopy.

In overview, a porous sample support provides a matrix into the pores or interstitial spaces of which a sample to be subjected to a spectroscopic analysis can be introduced. 2 D infrared spectroscopy can then be carried out on the sample at higher concentrations and with minimized background emission.

The two dimensional infra red spectroscopic sample support comprises a porous matrix with a pore size extending from 1 nm to 10 μm. The matrix may be optically transparent or have low absorption in the spectral regions of the laser beams, and preferably but not necessarily low scattering. In particular the matrix may be optically transparent at all wavelengths which impinge on the sample, The matrix preferably comprises a polymer, an organic or inorganic matrix.

The matrix of the present invention comprises pores of a diameter such that compounds of interest can be absorbed there into but sufficiently small that scattering of light by the pores is minimized. The pores may extend from 1 nm to 10 micrometres, more preferably from 1 nm to 1 micrometre. It will be appreciated that altering the pore size/pore diameter may allow the selective uptake of a molecule e.g. a protein of interest. The matrix is preferably, but not necessarily weakly scat g. The porous nature of the matrix allows high loading of e sample, providing a concentration effect which is parcularly advantageous for the analysis of any molecular samples. Thus the method of the present application provides significant benefits over the sample preparation techniques known in the art.

The matrix is optically silent or gives only a small signal in the IR region allowing accurate detection of samples. Furthermore, the matrix is preferably compatible with biological samples such as nucleic acids, proteins etc., allowing if necessary the samples to be observed in their native (i.e. non-denatured) and/or active forms. Denaturing matrices may be used in picular applications such as the detection of phosphorylation state of amino acids.

In a particularly preferred feature of the invention, the matrix is an inorganic matrix, more preferably a metal oxide porous film. The film is preferably provided at a thickness of 300 nm to 12 μm. The metal oxide film for the present invention comprises a mesoporous nanocrystalline metal oxide. In particular, the metal oxide is selected from ZnO₂, ZrO₂, TiO₂, SiO₂), SnO₂, CeO₂, Nb₂O₅, WO₃, SrTiO₃ or mixtures thereof, preferably TiO₂. The film preferably comprises nanometer sized crystalline particles having a typical diameter of from 5 to 50 nm, wherein the densely packed particles form a mesoporous structure providing a high surface area.

Mesoporous nanocrystalline metal oxide films such as TiO₂ films have a high surface area and an excellent optical transparency in the infra red region of the spectrum. These metal oxide films are therefore particularly useful for use in optical detection.

Alternatively, the matrix may comprise a transparent polymer film. Preferably, the polymer of the invention comprises a polyacrylamide or agarose gel. The use of such polymer films allows the separation of a mixture of compounds prior to infra red analysis by for example electrophoresis.

The matrix will ideally allow co-adsorbed sample or atmospheric water to be largely removed from the sample via evaporation at room temperature or via heating. As water produces a strong background signal, the ability to reduce the water content is advantageous. Much of the water co-adsorbed by proteins on TiO2 films evaporates at room temperature.

The matrix may be supported on a substrate. Such substrate is preferably selected from a polymeric glass matrix, a silicate glass matrix, sapphire, MgF₂ or CaF₂.

The present invention further relates to a two dimensional infra red spectroscopic sample preparation comprising the two dimensional infra red spectroscopic sample support and a sample in contact therewith. The sample may be absorbed onto the support or may be retained on the upper surface of the support. The sample may be retained or absorbed onto the support by ionic, covalent, or non-covalent interactions (e.g. van der Waals interaction).

The sample of the invention comprises preferably one or more of a organic molecule, a protein, a nucleic acid, a polysaccharide or a fragment thereof. The present invention is particularly directed to the analysis of a mixture of one or more organic molecules, of one or more proteins, of one or more nucleic acids of one or more polysaccharides. For the purposes of the present invention, the term protein encompasses polypeptides, antibodies, enzymes and fragments thereof.

It will be appreciated by a person skilled in the art that the interaction of the sample with the mat of the sample support will depend upon the properties of the sample and of the matrix of the sample support. Thus, when the matrix of the sample support is TiO₂, the negatively charged matrix will interact strongly with proteins having an overall positive charge or proteins having a concentrated positive charge. However, interaction of the TiO₂ matrix with a negatively charged protein may be poor. To his end, the present invention provides a modified sample support in which an additional polymer is added to the matrix. For example, the addition of a positively charged polymer such as poly-lysine (preferably poly-L-lysine) moiety to the TiO₂ matrix allows an improved interaction between the matrix and a negatively charged molecule such as a negatively charged protein, nucleic acid etc. The addition of such a polymer can modify the characteristics of the matrix to provide a more favourable environment for the sample, for example by providing a lipophilic or hydrophobic environment for a hydrophobic or lipophilic protein (such as a membrane protein).

The sample and support can be incorporated into a spectroscopic analysis in any appropriate form as will be apparent to the skilled reader. For the purposes of clarity one possible implementation will be described in which the sample support is incorporated into a spectroscopic apparatus of the type described in the aforementioned co-pending application GB0326088.2.

Referring to FIG. 1 the apparatus is shown generally as including a sample support 10, excitation sources 12, 18 comprising lasers emitting radiation typically in the infrared band and a detector 14. Tunable lasers 12 and 18 emit excitation beams of respective wavelengths/wavenumbers varying from 1000 cm⁻¹ to 16,000 cm⁻¹ which excite one or more vibrational modes of the molecular structure of the sample and allow multidimensional data by tuning the frequencies or providing variable time delays. A third, fixed frequency beam at 795 nm is generated by a third laser 16 to provide an output or read out in the form of an effectively scattered input beam frequency shifted (and strictly generated as a fourth beam) by interaction with the structure of sample 10. The detected signal is typically in the visible or near infrared part of the electromagnetic spectrum e.g. at 740 nm, comprising photons of energy not less than 1 eV. In order to obtain multi-dimensional data, the sample is excited by successive beams spaced in the frequency domain. However any appropriate multi-dimensional spectroscopic technique can be adopted, for example by varying the input in the time domain rather than or as well as the frequency domain or an arrangement such as that described in Zhao, Wright “Spectral Simplification in Vibrational Spectroscopy using Doubly Vibrationally Enhanced Infrared Four Wave Mixing”, J. Am. Chem. Soc. 1999, 121, 10994-10998, incorporated herein by reference. Similarly any number of dimensions can be obtained by additional pulses in the time domain or additional frequencies in the frequency domain and two or more vibrational states can be excited. Although a transmission scheme is shown, a reflection scheme (where the sample reflects the detected beam), or an evanescent scheme where the readout beam falls above the total internal reflection angle of the matrix, can be adopted where appropriate. In addition a scanning scheme in which the excitation beams are scanned across the substrate from one sample spot to another can be implemented.

In order to obtain improved sensitivity, parameters of the apparatus are varied so that heterodyne detection is achieved. This can be done either by providing an external heterodyne excitation source, for example comprising a further excitation laser or broadband laser source (not shown) or by tuning the excitation laser or parameters of the sample. For example automatic or self-heterodyning can be achieved by tuning the matrix properties to provide a heterodyning wave of appropriate strength and phase.

It will be seen, therefore, that the sample 10 comprises a porous support providing a matrix holding the sample as discussed in more detail above. In the event that a reflection scheme is adopted then the support and the provision of can be mounted on an appropriate substrate in the manner described in more detail below. Because of the concentration and localisation of the sample in the support and the provision of a matrix with multiple sample spots on it a small laser beam cross-section, for example 20-1000 microns is permissible and preferred.

One potential spectroscopic application is use of a supported sample following gel electrophoresis. As will be well known to the skilled reader, get electrophoresis comprises a technique for separating out components of a sample by flowing the sample in a direction transverse to an electric field, the sample being supported in a gel. The components are spatially separated according to this approach and typically a staining technique is applied to then identify the location of the various components. The spatial location can be used to derive information comprising the composition of the sample. Accordingly in order to provide a sample and support as discussed herein is simply necessary to dry the gel subsequent to electophoresis and then apply 2 D infrared spectroscopy to the dried gel forming a sample support. As a result additional information concerning the composition of the sample can be quickly and easily derived. In addition, as some gels may have selectable pore size, further variation in the parameters of the matrix is available.

In yet a further implementation the incident angle of the excitation beam in transmissive, reflective or evanescent mode or using fibre coupling can be varied so as to induce total internal reflection. As is well known this produces an evanescent wave on the other side of the interface whose intensity decays exponentially with distance from the interface. An appropriate apparatus is described in Moulton et at, “ATR-IR spectroscopic studies of the influence of phosphate buffer on adsorption of immunoglobulin G to TiO₂”, Colloids and Surfaces A: Physicochem. Eng. Aspects 220 (2003) 159-167, incorporated herein by reference. As a result an excitation effect will only be observed in rte vicinity of the interface as a result of which the depth of excitation can be controlled. In particular, the incident angle is set so that the beam penetrates a set distance into the matrix rather than transmitted. This allows tuning of the sampled thickness and avoids sampling the fl depth for example where the top layer has sample adsorbed. It also further reduces background emission from the support.

The present invention further provides a process for the production of a two dimensional infra red spectroscopic sample support comprising contacting a substrate with a porous matrix. For the purposes of the invention, the porous matrix is preferably a metal oxide film. The contacting of the substrate with a porous matrix can be carried out with the application of heat and/or pressure.

The application of the sample support to the substrate can be carried out by spray coating. It will be appreciated that the production of the substrate supported sample support will depend on the affinity of the substrate for the sample support. Porous metal oxide films such as TiO₂ can have good affinity for glass substrates such as borosilicate glass, TiO₂ films with a thickness of 12 micrometres can be deposited onto a glass substrate of 100 micrometres. Such thickness of sample support films have not previously been used in the art. In a particular feature of the invention, the substrate and in particular a glass substrate can be etched prior to the application of the sample support. This enables the application of the sample support onto thinner substrates. For example, the deposition of TiO₂ was carried out over an etch point to provide a TiO₂ film deposited on a 25 micrometre glass substrate.

Alternatively, substrates such as CaF₂ or sapphire may require additional processing steps to enable the application of the sample support. For example, the substrates may require initial spray coating with titania, followed by the application of TiO₂ in multiple layers (for example one or more 4 micrometre layers) by spray coating. Such an application process allows the formation of stable sample support-substrate preparations.

The matrix may be supported on a substrate for example, a polymeric or silicate glass matrix, sapphire, MgF₂ or CaF₂. The matrix may cover all or a part of the substrate. In a preferred feature of the invention, the matrix may contain one or more additional ligating groups to attach the matrix to the substrate.

The matrix may form an array on the substrate. The matrix can therefore provide a conveniently shaped sensing area on the substrate. The array can be provided as discrete areas or dots on the substrate, for example by screen printing.

The invention further relates to a process for the production of a two dimensional infra red spectroscopic sample preparation wherein a sample is introduced onto a sample support and water is removed there from.

Preferably, the sample is absorbed onto the substrate. The sample may be deposited via screen printing, spin coating, doctor blading or inkjet printing. The support may subsequently undergo one or more additional processing steps such as heat sintering, low temperature compression and/or compression.

A further advantage of providing a support as discussed above is that the sample can be provided in a thin film configuration for example of thicknesses 300 nm-12 μm. It is found that such thin films are particularly suitable in cases where it is desired to carry out heterodyne detection allowing low concentrations of sample to be analysed. The general manner in which a sample can be tuned is set out GB0326088.2 and is summarised here for ease of reference.

By way of definition, all the spectroscopic methods including the present invention emit a signal whose intensity can be defied as follows:

I=(E_{LO})²+(E_{HO})²+(E_{LO}×E_{HO}) cos φ (1)

Here, E_{HO} is the homodyne signal from the sample; it can be thought of as the sum electric field which is emitted by the sample component of interest. E_{LO} is a “local oscillator” field, that is, a field of identical frequency present on the detector with a fixed phase difference φ. In standard homodyne detection, there is no local oscillator field, and the intensity is simply the homodyne term E_{HO}², which varies quadratically with the concentration of the chemical system under study. In heterodyne detection, a separate local oscillator is created and made to coincide in time and space on the detector. By so doing, and removing the (E_{LO})² term by any appropriate technique which will be familiar to the skilled reader the cross term can be made to dominate the equation. With knowledge of the local oscillator strength, the output field is then linear in concentration.

As a result a coherence spectroscopy approach is provided in instances where phase matching takes place which can be obtained by varying parameters of the sample to ensure that a local oscillator field provides a non-resonant contribution significantly (say ten times) larger than the resonant contribution or homodyne portion of the signal. As a result the E_{LO} and cross terms can be made to dominate equation (1) and the signal can be effectively considered as heterodyned. As such, the signal is linear in concentration allowing far lower concentrations to be achieved before reaching the limit of detection. By varying the material of the support, matrix dimensions or volume or thickness of the support, the relative size of the local oscillator contribution can be controlled, allowing a great deal of range in the concentrations that can be examined. As a result not only can an IR-silent support be selected but it can be further tuned to enhance heterodyne detection.

In intra-sample cases such as these where the local oscillator field is internally or intrinsically generated the (E_{LO})² term can be removed by identifying and subtracting the characteristic local oscillation signal which can be obtained in a calibration step.

The invention can be implemented in a range of applications and in particular any area in which multi-dimensional optical spectroscopy measuring, directly or indirectly, vibration/vibration coupling is appropriate, using two or more variable frequencies of light at least one of which is IR or time delays to investigate molecular identity and/or structure, either using heterodyne or homodyne detection.

The skilled person will recognise that any appropriate specific component and techniques can be adopted to implement the invention. Typically at least one tunable laser source in the infrared and at least one other tunable laser source in the ultraviolet visible or infrared can be adopted and any appropriate laser can be used or indeed any other appropriate excitation source. A further fixed-frequency beam may also be incorporated in the case of two infrared excitation beams as discussed with reference to FIG. 1 and again any appropriate source can be adopted. Any appropriate detector may be adopted, for example a CCD or other detector as is known from 2 D IR spectroscopy techniques.

The range of excitation wavelengths is generally described above as being infrared but can be any appropriate wavelength required to excite a vibrational mode of the structure to be analysed. Although the discussion above relates principally to two-dimensional analysis, any number of dimensions can be introduced by appropriate variation of the parameters of the input excitation, for example frequency, dime delay/number of pulses or any other appropriate parameter. In addition the technique can be extended to excitation of electronic state or a mix of electronic or vibrational states.

The approach can further be implemented in relation to any appropriate form of 2 D spectroscopy for example steady state IR spectroscopy where temperature cycling provides two dimensional information of the type described in Tee et at “Probing Microstructure of Acetonitrile—Water Mixtures by Using Two-Dimensional Infrared Correlation Spectroscopy” J. Phys. Chem. A 2002, 106, 6714-6719. In addition the approach has advantages in relation to IR spectroscopy generally as water can be removed by evaporation from the matrix once the sample is bound, reducing background. This advantage is significantly enhanced for multi-dimensional spectroscopy which employs multiple IR beams.

1. A two-dimensional infra red spectroscopic sample support comprising a porous matrix.

2. The sample support of claim 1 whereby the matrix has a pore size of from 1 nm to 10 μm.

3. The sample support of claim 1 wherein the matrix is optically transparent.

4. The sample support claim 1 wherein the matrix comprises at least one of a polymer, an organic an inorganic matrix.

5. The sample support claim 1 wherein the matrix comprises a metal oxide porous film.

6. The sample support of claim 5 wherein the metal oxide film comprises a mesoporous nanocrystalline metal oxide.

7. The sample support of claim 5 wherein the metal oxide film is selected from the group consisting of ZnO₂, ZrO₂, TiO₂, SiO₂, SnO₂, CeO₂, Nb₂O₅, WO₃, and SrTiO₃.

8. The sample support claim 5 wherein the metal oxide film comprises nanometer sized crystalline particles having a typical diameter of from 5 to 50 nm.

9. The sample support of claim 1 wherein the matrix comprises a dehydrated polyacrylamide gel.

10. The sample support of claim 1 wherein the matrix comprises at least one of a porous sol and a gel.

11. The sample support of claim 1 wherein the matrix is supported on a substrate.

12. The sample support of claim 11 wherein the substrate is at least one of a polymeric glass matrix, a silicate glass matrix, sapphire, MgF₂ and CaF₂.

13. A two dimensional infra red spectroscopic sample preparation comprising the sample support claim 1 and a sample in contact therewith.

14. The sample preparation of claim 13 wherein the sample is at least one of an organic molecule, a protein, a nucleic acid, a saccharide, a fragment of an organic molecule, a fragment of a protein, a fragment of a nucleic acid, and a fragment of a saccharide.

15. The sample preparation of claim 13 wherein the sample is in at least one of ionic, covalent and van der Waals interaction with the sample support.

16. A two-dimensional spectroscopy apparatus comprising an excitation source and the sample support of claim 1.

17. The apparatus of claim 16 comprising a two dimensional infrared spectroscopy apparatus.

18. The apparatus of claim 17 comprising an evanescent wave geometry spectroscopy apparatus.

19. A method of two-dimensional spectroscopy comprising exciting a mode of a sample in contact with the sample preparation of claim 13.

20. The method of claim 19 comprising exciting at least one of a vibrational mode and an electronic mode.

21. A process for the production of the two-dimensional infra red spectroscopic sample support as defined in claim 1 comprising contacting a substrate with a matrix.

22. The process of claim 21 wherein the substrate is contacted with the matrix under the application of at least one of heat and pressure.

23. A process for the preparation of a two dimensional infra red spectroscopy sample preparation comprising the application of a sample to a two dimensional infra red spectroscopic sample support claim 1 and removal of water from the preparation.

24. The process of claim 23 wherein the sample is applied to the sample support by at least one of screen printing and gridding by a gridding robot.
